(19) United States
(12) Patent Application Publication
(10) Pub. No.: US 2002/0070469 A1
(43) Pub. Date: Jun. 13, 2002

(54) Method and apparatus for optimizing a rubber manufacturing process

(76) Inventors: Roger D. Hiatt, Canton, OH (US); John A. Sezna, Akron, OH (US)

Correspondence Address: Robert H. Earp, III, Benesch, Friedlander, Coplan & Aronoff LLP, 2300 BP Tower, 200 Public Square, Cleveland, OH, 44114-2378, US

(21) Appl. No.: 09/736,081

(22) Filed: Dec. 13, 2000

Related U.S. Application Data
(60) Provisional application No. 60/170,465, filed on Dec. 13, 1999.

(51) Int. Cl. B29B 7/02; B29B 7/30; G01B 1/00

(52) U.S. Cl. 264/40.1; 700/197; 425/135; 425/143

(57) ABSTRACT

This invention comprises a method and apparatus for optimizing a rubber manufacturing process having multiple process steps, wherein the process steps can be adjusted during the manufacturing process to achieve a desired rubber product, the method comprising obtaining a rubber material sample during the manufacturing process; analyzing the rubber material sample to generate processability data; comparing the generated processability data with known processability data; determining any process adjustments required to achieve optimal processability of the rubber material sample; and means for implementing the process adjustments during the rubber manufacturing process to achieve a desired rubber product.

This invention utilizes rubber material samples taken at any stage of the rubber manufacturing production process and tests those samples using rheological testing equipment. The data obtained from the rheological testing equipment is sent to a central database and store for future use and used to determine the quality and processability of the rubber material sample. Evaluation and decision-making software analyzes the processability data and compares that data to known processability data to determine the most appropriate processability parameters for the batch. Once the evaluation and decision-making software has chosen a course of action, the production parameters are sent to their respective production equipment for processing the batch accordingly. This testing, evaluating, decision-making, and executing process can be repeated at any and all production steps to obtain a desired rubber product.

### CROSS-REFERENCE TO RELATED APPLICATIONS

This application claims the benefit of U.S. Provisional Patent Application Serial No. 60/170,465, filed on Dec. 13, 1999, that is herein incorporated by reference herein.

### FIELD OF THE INVENTION

The present invention relates to a method and apparatus for optimizing a rubber manufacturing process, and in particular, a method and apparatus for analyzing a rubber material sample and implementing any process adjustments during the manufacturing process to achieve a desired rubber product.

### BACKGROUND OF THE INVENTION

In a rubber processing and manufacturing facility, a typical process may consist of an incoming raw material operation, a compounding operation, a mixing operation, a milling operation, a product shaping operation, and a curing operation.

Rubber compounds are typically produced in a batch process of one or two stages. Raw rubber is normally combined with various ingredients, such as fillers and other additives, to enhance the physical and chemical properties of the desired rubber product. The first stage rubber compound is typically a mixture of several raw materials such as SBR, carbon black, and oil. Furthermore, the addition of these fillers and additives can assist in the processability and cureability of the rubber material. It is common to produce a master batch, that is, a pre-mixture of filler, elastomer, and various optional additives, such as extender oil. The compound is typically made according to a recipe by weighing out each component and combining them in a Banbury mixer. If the first stage mix is followed by a second stage mix containing curative materials, the first stage is called a master batch, and the second stage is called a final mix.

Incoming raw materials may be tested prior to the mixing operation using a rotational viscometer test instrument. A Mooney viscometer (or simply Mooney), named after its inventor Melvin Mooney, is a commonly used rotational viscometer used to test viscosity and pre-cure properties of raw rubbers and rubber compounds. A rotational viscometer tests a raw material sample by applying a rotational shear strain at a constant velocity and at a constant temperature according to ASTM D1646. The test instrument is usually located in a lab and monitored by a lab technician having specific knowledge regarding the rubber manufacturing process. A sample of the raw material is taken to the lab, tested, and the results are typically recorded by a printer or recording device connected to the test instrument. Acceptance or rejection of the raw material is determined by the lab technician who interprets the test results. Acceptable raw materials proceed to the mixing operation while unacceptable raw materials may be discarded or sent back to the supplier.

After the first stage mixing operation, the master batch is usually only tested for specific gravity, to assure proper filler levels, and occasionally tested by a Mooney viscometer for processability. The use of master batch Mooney viscometer tests for processability, however, is limited because the test takes too long and requires significant operator attention to keep up with rapid mixing cycles. Therefore, typically in the rubber manufacturing prior art, very little acquired processability data is used to ensure the proper mixture and production of a desired rubber material.

The accepted master batch may be mixed a second time, where the curative materials are added. If a test instrument is available, the final mix is sampled and tested after mixing and milling. The final mix is tested for processability and curability using an Oscillating Disk Rheometer (ODR) or a simple moving die rheometer (MDR). Typically, a sample is taken from the batch and transferred to the lab for testing. An ODR, or a simple MDR, tests the sample by applying a constant oscillatory strain at a constant frequency and at a constant temperature, according to either ASTM D2084 or ASTM D5289. The lab technician evaluates the results and determines whether or not to accept the mixture. The acceptable final mix proceeds to the next operation, while the rejected master batch is usually scrapped or reworked. The acceptable material is then ready for processing into a finished part like a hose, a belt, or an industrial rubber product. After shaping by extrusion or molding, the part is cured to develop the unique properties of rubber.

The prior art method and apparatus for manufacturing rubber is limited because the processability testing takes too long and requires significant operator attention to keep up with the rapid mixing cycles and data evaluation. Because rubber testing takes such a long time, and the results must be interpreted by a skilled technician, very little processability information is used which may optimize the rubber manufacturing process. Further, based on the skill of the lab technician, batches of rubber may be unnecessarily discarded or permitted continued manufacturing if the lab technician makes an error or is not skilled enough in the art. Because acceptability decisions and possible re-working recommendations are made by humans, the decisions and recommendations may vary depending on the education, experience, and skill level of the lab technician. Therefore, the production of rubber on different days during different shifts at different lines may result in dramatic inconsistencies in terms of quality and productivity.

Therefore, there is a need in the art for a more reliable rubber manufacturing process having quicker testing time, preferably automated testing, and more accurate analysis of the resultant data to determine whether a batch is acceptable or not.

There is also a need in the art to acquire and maintain knowledge in the field of rubber testing and manufacturing wherein the rubber manufacturing process can be managed in real-time so as to automatically adjust process steps in real-time to achieve a desired rubber product.

There is also a need to minimize the human involvement in the prior art rubber manufacturing process to minimize human error and minimize human evaluation time.

There is also a need for a more efficient rubber manufacturing process that will increase productivity and reduce expenses associated with rubber processing. A more efficient rubber manufacturing process will reduce scrap and downtime which will increase overall productivity.

### SUMMARY OF THE INVENTION

Accordingly, the present invention provides for a method for optimizing a rubber manufacturing process by automatically adjusting each process step in real-time to achieve a desired rubber product. The present invention also minimizes the human involvement associated with the prior art rubber manufacturing process by automating the rubber manufacturing process through the use of in-line production rubber process analyzer, evaluation and decision-making software, a central database, and equipment control circuitry connecting the rubber processing equipment and the database. The evaluation and decision-making software compares the in-process testing results with known rubber processing information accessible to the database and automatically makes decisions on how to adjust the process to achieve optimal results based on the desired product. These decisions and recommendations are immediately transmitted to equipment control circuitry that controls and adjusts the rubber processing equipment thereby minimizing the chance that a human will make a mistake in interpreting the results and make a poor decision based on that interpretation.

Furthermore, the present invention provides for a more efficient rubber manufacturing process that increases productivity and reduces expenses associated with rubber processing. The present invention reduces scrap by continuously adjusting the rubber manufacturing process following test results evaluated by the evaluation and decision-making software. Downtime is reduced because the rubber testing equipment is located in the production area (or “in-line”) near the processing line thereby allowing for quicker turn around time for test results. Finally, expenses are reduced by automating the process wherein the number of employees needed to operate the processing equipment and test the samples is decreased.

In accordance with this invention, a method is disclosed for optimizing a rubber manufacturing process wherein the process steps can be adjusted during the manufacturing process to achieve a desired rubber product, wherein the method comprises obtaining a rubber material sample during the manufacturing process; analyzing the rubber material sample to generate processability data; comparing the generated processability data with known processability data; determining any process adjustments required to achieve optimal processability of the rubber material sample; and means for implementing the process adjustments during the rubber manufacturing process to achieve a desired rubber product. An apparatus in accordance with this invention is also disclosed.

### BRIEF DESCRIPTION OF THE DRAWINGS

FIG. 1 is a block diagram indicating the typical operations in a rubber manufacturing process;

FIG. 2 is a diagrammatic view indicating the typical operations, testing, and decision making in a rubber manufacturing process;

FIG. 3 is a diagrammatic view of a rubber manufacturing process utilizing testing equipment of this invention at various stages in the rubber manufacturing process;

FIG. 4 is a diagrammatic view of a rubber manufacturing process utilizing testing equipment at various stages in the rubber manufacturing process and decision-making equipment to analyze the testing results; and

FIG. 5 is a diagrammatic view of the preferred embodiment of a rubber manufacturing process utilizing testing equipment and decision-making equipment in a rubber manufacturing process.

### DETAILED DESCRIPTION OF INVENTION

The present invention includes a method and apparatus for optimizing a rubber manufacturing process. This invention preferably utilizes equipment, explained in detail below, including a production rubber process analyzer (“RPA”) to analyze a rubber material sample and generate processability data, ECLIPSES® evaluating and decision-making software to evaluate the processability data and determine any process adjustments required to achieve optimal processability, and machine control circuitry to implement mixer and process controls based on the suggested process adjustments.

The present invention comprises a method for optimizing a rubber manufacturing process having multiple process steps, wherein the process steps can be adjusted during the manufacturing process to achieve a desired rubber product, the method comprising obtaining a rubber material sample during the manufacturing process, analyzing the rubber material sample to generate processability data, comparing the generated processability data with known processability data, determining any process adjustments required to achieve optimal processability of the rubber material sample, and means for implementing the process adjustments during the rubber manufacturing process to achieve a desired rubber product.

The present invention also comprises an apparatus for optimizing a rubber manufacturing process having multiple manufacturing steps, the apparatus comprising testing equipment for generating processability test data for a material sample; a central database capable of receiving the processability test data, the central database having access to known processability data; evaluation and decision-making software accessible by the central database for comparing the processability test data with the known processability data and determining any process adjustments required to achieve a desired processability; and equipment control circuitry connecting the processing equipment and the central database to implement the process adjustments.

The method and apparatus of this invention will be better understood when reading this description with reference to the accompanying drawings.

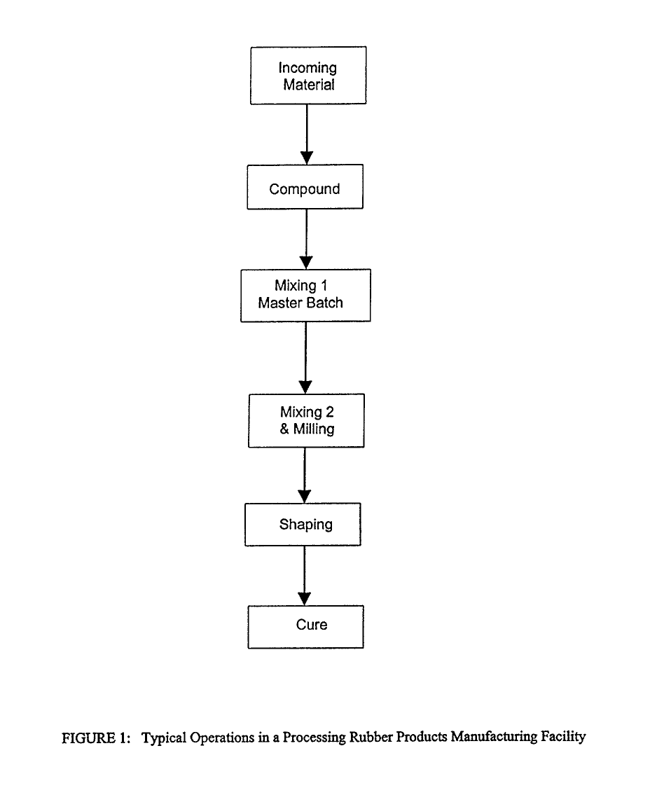

FIG. 1 is a diagrammatic view of the steps utilized in a typical rubber manufacturing process. In general, incoming raw materials are identified and compounded (mixed) together based on a predetermine rubber recipe to form a master batch. This master batch can be mixed, milled, shaped, and cured to obtain a desired rubber product.

It is understood that this invention could be utilized with only a single process step to optimize the results of that step. It is also understood that this invention could be utilized with only one of several process steps to optimize the results of any or all process steps. However, this invention will be described herein as utilized with a number of identified rubber manufacturing process steps to optimize the results of any and all steps within the manufacturing process.

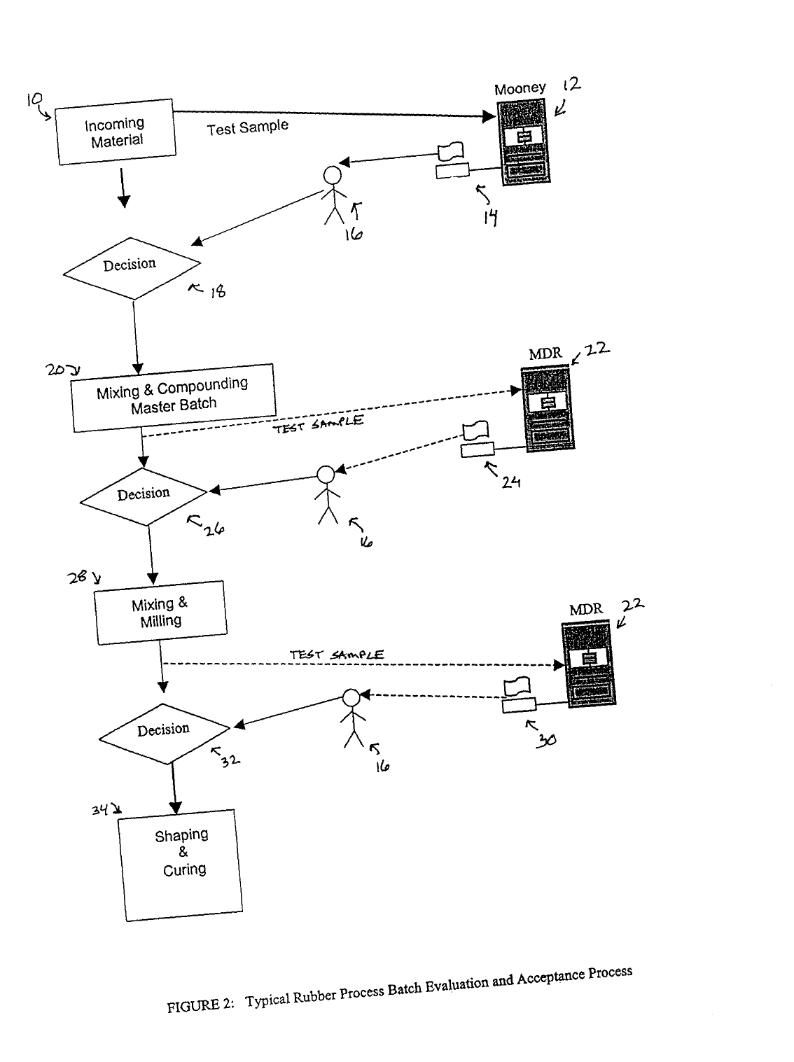

FIG. 2 is a diagrammatic view indicating the typical manufacturing, testing, and decision-making process in a prior art rubber manufacturing process. As known in the art, incoming raw materials 10 may be tested prior to the mixing operation 20 using a rotational viscometer test instrument 12 (i.e. a Mooney viscometer). A Mooney viscometer 12 is commonly used to test viscosity and pre-cure properties of raw rubbers and rubber compounds. A rotational viscometer 12 tests a raw material sample by applying a rotational shear strain at a constant velocity and at a constant temperature according to ASTM D1646. The results of this Mooney viscometer test can indicate the processability fitness of the raw materials and fillers based on a prescribed rubber recipe.

The Mooney test instrument 12 is typically located in a lab remote from the rubber manufacturing line and is monitored by a lab technician 16. Typically, a sample of the raw material or filler material 10 is taken to the lab, tested, and the results are printed 14. These test results 14 must be reviewed and interpreted by the lab technician 16 who decides 18 whether to accept or reject the incoming material 10 for further processing. Acceptable incoming materials 10 are sent through the mixing operation 20 as a mater batch and unacceptable raw materials 10 may be discarded or sent back to the supplier. Such resultant materials although utilizing different name designations will nonetheless be referenced using the same number.

Optimally, samples of the rubber material 10 are tested by an MDR 22 after the mixing operation 20 to determine the processability of the master batch 10 to determine if optimal processability has been achieved. A sample of the rubber compound 10 is taken back to the lab, tested, and the results 24 printed. A simple moving die rheometer (MDR), or Oscillating Disk Rheometer (ODR), tests the sample by applying a constant oscillatory strain at a constant frequency and at a constant temperature, according to either ASTM D2084 or ASTM D5289. The lab technician 16 reviews and interprets the results to decide 26 whether or not to accept the compound 10. The acceptable master batch 10 proceeds to the next operation (possibly a second mixing operation 28), while the rejected master batch is usually scrapped or reworked. If the master batch is reworked, the lab technician 16 must have the technical knowledge to determine how to rework the master batch in order to achieve the optimal processability required by the manufacturing process.

The accepted final mix may be mixed a second time 28, where the curative materials are added. If a test instrument is available, the final mix is sampled and tested after mixing and milling 28. The final mix is tested for processability and curability using an MDR or ODR 22 as explained above. The lab technician 16 reviews and interprets the results 30 to decide 32 whether or not to accept the compound 10. The acceptable master batch 10 proceeds to the next operation, possibly the shaping and curing operation 34, while the rejected master batch is usually scrapped or reworked. Once again, if the master batch is reworked, the lab technician must have the technical knowledge to determine how to rework the master batch in order to achieve the optimal processability required by the manufacturing process.

In the prior art manufacturing process, the master batch 10 is usually only tested for specific gravity, to assure proper filler levels, and occasionally tested by a Mooney viscometer 12 for processability. The use of master batch Mooney viscometer tests for processability, however, are limited because the tests are time consuming and require significant lab technician attention to keep up with rapid mixing cycles. Therefore, typically in the rubber manufacturing prior art, very little acquired processability data is used to ensure the proper mixture and production of a current rubber material.

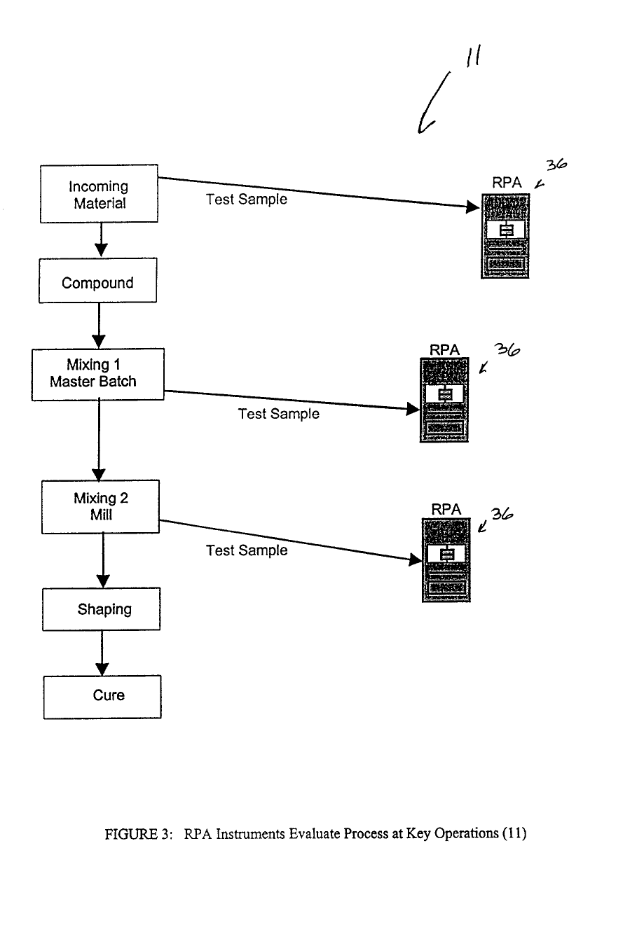

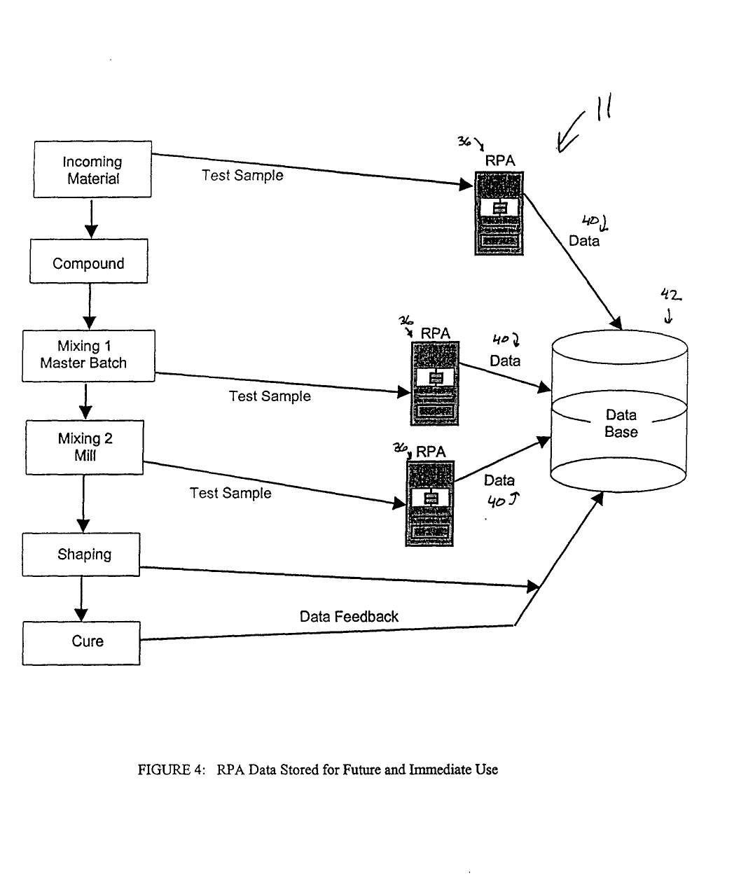

The method and apparatus of this invention, shown in FIGS. 3 through 5, utilize a production rubber process analyzer (RPA) 36 and decision-making software (ECLIPSE® Software) 38 to optimize the rubber manufacturing process. As shown in FIG. 3, samples of the processed material (i.e. incoming raw material/filler material and subsequent rubber compounds), can be taken from any step in the production line and transferred to an apparatus capable of evaluating the viscoelastic properties of the sample. Although any rheological tester for determining viscoelastic properties could be utilized for this invention, the preferred embodiment utilizes a production rubber process analyzer (“RPA”) 36 available from Alpha Technologies U.S., L.P., 2689 Wingate Avenue, Akron, Ohio 44314. The removal, transfer, loading, and unloading of the sample (either raw material, filler material, or rubber material sample) from the batch to the RPA 36 can be performed either manually or through an automated process.

The RPA 36 is used to gather processability data by measuring the viscoelastic properties of the sample 10. Materials which can be tested include raw polymers, uncured rubber compounds, compounds cured in the RPA, and other thermoset materials. The RPA 36 can characterize the sample 10 before, during, and after cure by varying frequency, strain, and temperature on one test sample. The information determined by utilizing the RPA 36 includes, but is not limited to:

Polymer Characterization—detecting small variations in molecular structure with stress relaxation, frequency, and strain tests;

Uncured Rubber Processability—tests including viscosity vs. shear rates and elastic and viscous shear modulus with stress relaxation, frequency, strain, and temperature tests;

Rubber Cure Reactions—observing cure under static and dynamic conditions as well as performing cure simulations following temperature profiles; and

Cured Rubber Properties—determining the cured dynamic properties with temperature, frequency, and strain sweeps.

Once the RPA 36 has performed the required tests on the rubber material sample 10, the resultant data 40 is transferred to a central database 42. The central database 42 includes a user interface, memory capabilities, access to evaluation and decision-making software 38, and means for controlling production parameters during the rubber manufacturing process.

Data 40 that is generated by the RPA 36 on a particular batch is transferred to the central database 42 and stored therein. The central database 42 uses the data 40 obtained from the RPA 36 and compares that data 40 to known processability data accessible to the central database 42. The central database 42 utilizes an evaluation and decision-making software to provides recipe development tools, test data evaluation, and production process monitoring. The preferred embodiment of this invention utilizes ECLIPSE® software available from Eclipse Technical Software Service, a subsidiary of Alpha Technologies U.S., L.P., 2689 Wingate Avenue, Akron, Ohio 44314. The ECLIPSE® software utilizes four key elements in evaluating data and making appropriate decisions based on that data:

(1) COMPOUND® is a flexible recipe management system that greatly simplifies the development of new recipes. COMPOUND® creates new formulations based on compound properties or the use of ingredients in the existing recipe database; generates mixing procedures, production plans, and working orders in the same software environment; and is supplied with INGBASE, an ingredients database with approximately 2000 raw materials used in the rubber industry and can easily be linked to the databases provided by information supplying companies;

(2) DAISY® is a data acquisition system that collects and evaluates data from test instruments. DAISY® automatically acquires data from attended or unattended instruments; collects data for quick, comprehensive, on-line statistical process analysis (SPC) and reporting for quality control; views, plots, and compares curves of results; recalculates data points from stored tests; selects, views, and carries out work orders generated by COMPOUND®; reviews and improves test procedures and/or process monitoring; and connects virtually any type of test and measurement instrument either directly or via the custom interface;

(3) MAISY® is a data acquisition system that collects and analyses data from mixing and processing equipment. MAISY® displays the collected data graphically; stores process results and graphs for analysis and comparison with test results from DAISY®; retrieves recipe information and downloads it to a computer controlling the mixing process;

(4) LABFILER® is a program for freely definable customer reports and for general database management; and

(5) The NEURAL NETWORK is a software application that performs the decision-making functions based on collected and generated information from these systems and other remote systems accessible to ECLISPE® and transmits the decision parameters through machine control circuits to control the rubber manufacturing process.

ECLIPSE®, can analyze the RPA resultant data 40 and compare it to know viscoelastic data to determine the optimum recipe based on the raw materials, determine current mixing, milling, or curing control parameters, or determine subsequent mixing, milling, or curing parameters for subsequent process steps. The known processability data includes stored viscoelastic data from rubber material samples taken during various steps of prior manufacturing processes, stored viscoelastic data from rubber material samples taken during previous steps of the current manufacturing process, and other known viscoelastic data. The known processability data further includes suggested manufacturing process parameters necessary to obtain optimal processability characteristics of a rubber material sample based on said stored viscoelastic data. ECLIPSE® can compare the resultant RPA data to the known processability data and analyze the information to determine process parameters required to optimize the processability of the rubber material sample. For example, ECLIPSE® could, based on the resultant data generated by an RPA at a designated site in the manufacturing process, determine that the compound should be mixed for a longer period of time, at a greater speed, or at an increased temperature to achieve the processability for the compound required by the manufacturing process. ECLIPSE® could determine that the subsequent step requires mixing for a longer period of time, at a greater speed, or at an increased temperature. Other manufacturing control parameters known in the rubber manufacturing industry could likewise be controlled using ECLIPSE®. The central database 42 utilizing ECLIPSE® communicates with the process equipment through machine control circuits 22 which operate the equipment as required by ECLIPSE®. ECLIPSE® can also utilize what is called the “neural network” to retrieve information remote from the central database, an intranet, or the internet. The “neural network” can gather data, transfer information, share information, etc. in order to increase the efficiency of the manufacturing process.

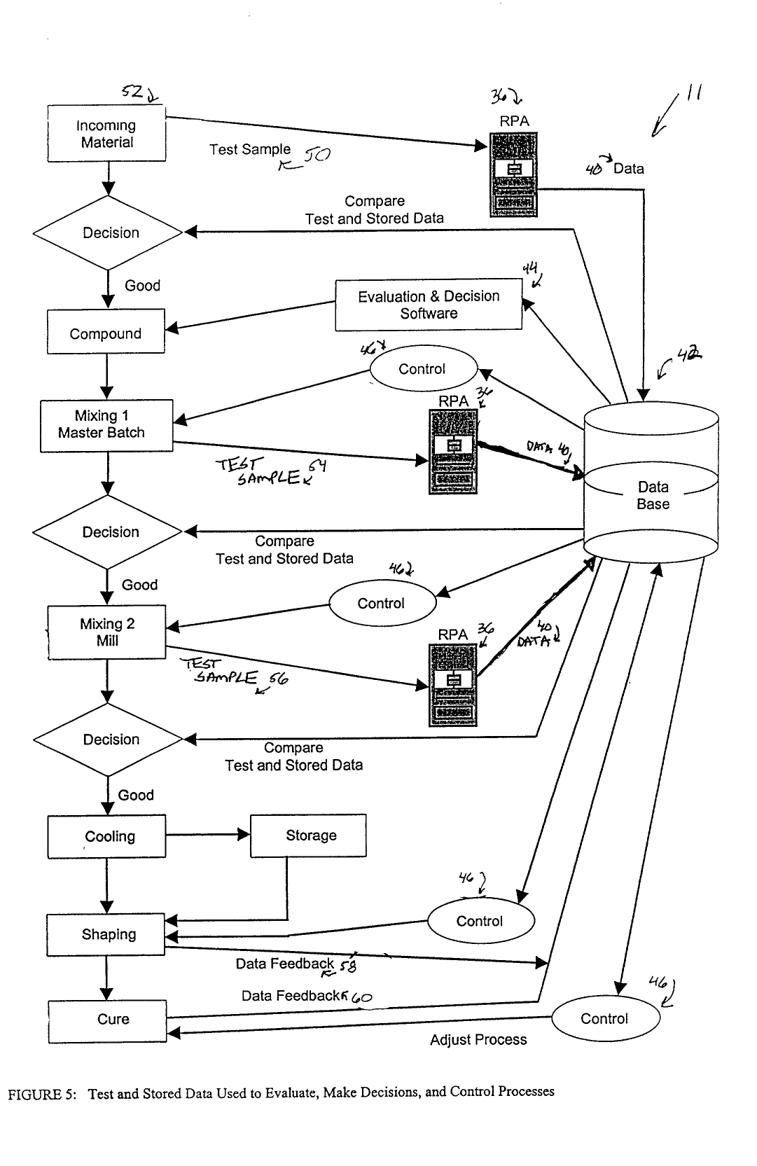

A detailed description of the method and apparatus of this invention, as shown in FIG. 5, is as follows. The rubber process optimizer system (RPOS) of this invention, generally designated as 11, consists of one or more RPA instruments 36, a central database 42, evaluation and decision making ECLIPSE® software 44, and equipment control circuitry 46 connected to the central database 42. Utilizing this invention, RPA instruments 36 are used at any number of key operations to evaluate the progress of the process. RPAs, although similar to MDRs, can be programmed for an infinite number of combinations for strain, frequency, and temperature settings that simulate factory process conditions and can be located at the production line instead of in a lab remote from the production line. Brochures labeled Brochure A, Brochure B, Brochure C, and Brochure D further explain RPAs and their use and these brochures are hereby incorporated by reference herewith. Although RPA instrument test points could be located anywhere along the process line, it is preferred that RPAs test the incoming raw materials, the master batch mix processability, the final mix processability, the final mix cure test, and the final mix cure properties.

Referring specifically to FIG. 5, a technician or automated equipment will take a test sample 50 from the batch of incoming material 52 and place it within the RPA 36 for testing. Nothing needs to be done to the sample 50 before the test. The traditional testing method requires a sample to be transferred quickly from the product line to the lab for testing and analysis by the lab technician. With the present invention, the RPA 36 can be placed near the production line to perform any tests “in-line” during production in order to save time and money. Resultant test data 40 from the RPA 36 is then transmitted directly to and stored in a central database 42 for both future general use and immediate use by other operations in the process.

The resultant test data 40 can be immediately used by the ECLIPSE® software to determine the processability of the incoming raw materials and fillers 52 and/or to modify the rubber recipe to obtain a specified rubber product. Brochures labeled Brochure E and Brochure F further explain the software and its use and these brochures are hereby incorporated by reference herewith. Based on the analysis between the resultant test data 40 and the known processability data accessible by the central database 42, the ECLIPSE® software identifies the appropriate recipe composition and determines the appropriate compounding parameters (i.e. time, speed, and temperature) in order to achieve a desired rubber product. Such composition or process parameters are transferred to the production line by machine control circuitry 46 at each process stage to control the production equipment.

Raw materials used in the production process can vary in quality. Samples 50 of the incoming raw materials 52 are tested on an RPA 36 to quantify this variability in order to implement changes in mixing and processing to improve the ultimate quality and uniformity of the product. The RPA 36 performs tests such as polymer testing and filler testing. A typical polymer test is the ASTM D6204 test. The ASTM D6204 test is used to grade the polymers and usually takes less than 4 minutes. This test can be programmed directly into the RPA 36, however, any test requiring varying frequency, strain, and temperature can be performed in any of the RPAs 36 to evaluate the material. Once the polymers are graded, the resultant test data 40 is stored in the central database 42 and compared to known data for similar raw materials. The ECLIPSE® software compares and analyzes the resultant data 40 and the known data and recommends any action to be taken, such as rejecting the materials (send them back to the supplier), adjusting the formula to be used (standard Cad/Chem software can suggest modifications to the formula to achieve desired results), or adjusting the mixer or subsequent process equipment through the machine control circuits 46. If accepted, the materials may be mixed with other materials that will produce the final product.

Filler testing is used to determine the properties of the fillers. Usually a reference batch is mixed and tested in the lab to determine its properties. The information is then sent to the database 42 where the ECLIPSES® software recommends the action to be taken, such as rejecting the filler (send back to the supplier), adjusting the formula (Cad/Chem), or adjusting the mixer (mixer control).

Once the raw materials are accepted, they are combined in a prescribed manner (a recipe) in a process called compounding. Based upon characteristics stored in the central database 42 for each raw material and the desired end product, the ECLIPSE® software may adjust the recipe ingredients to achieve an optimized end product. After the raw materials are combined, they must be carefully and thoroughly mixed into a “master batch”. The manner in which the materials are mixed can be monitored and modified by machine control circuitry 46 based upon information stored in the central database 46 through controlling such mixer parameters as speed and time. After the mixing operation, a sample 54 is tested for processability by an RPA 36 to determine if the mix is acceptable or not. ASTM D6204 is a standard processability test which grades the master batch. RPA resultant data 40 from the mixing operation is then sent to the central database 42 where it is stored and compared to stored known data for the desired product output using the ECLIPSE® software. As a result of this comparison, the ECLIPSE® software recommends any action to be taken, such as adjusting the formula (Cad/Chem), adjusting the mixer (mixer control), reworking, or scrapping the batch.

The accepted first mix, or master batch, may be mixed a second time at a mixing and/or milling operation. At the end of the milling process, an RPA 36 tests a batch sample 56 for processability and curability using the standard ASTM D6204 test followed immediately by an ASTM D5289 cure test to grade the final mix. Resultant data from the RPA 36 is stored in the central database 42 and compared to known processability and curability parameters accessible by the central database 42 to determine if the mix is acceptable or not, and the ECLIPSE® software, if necessary, recommends action such as adjusting the process parameters (i.e. the mixing controls (46)), reworking the batch, or scrapping the batch. If the batch is accepted, a cooling or storage period may be required for the mix before the next process. The ECLIPSE® software may also determine the parameters required for the proper cooling and storage sample.

Prior to curing, the mix may be preformed into a specific shape. Shaping machinery, like mixing machinery, can be monitored and modified by machine control circuitry 46 based upon information in the central database and controlling such parameters as speed, thickness, and delay before curing. A test sample can be tested in an RPA (not shown), to determine the potential for processing in the shaping operation. Data 58 from the shaping machinery is then stored in the central database 42 and compared to shaping and curability parameters in the central database 42. The ECLIPSE® software, if necessary, recommends action to be taken such as adjusting the process parameters (i.e. the process or cure controls), reworking the batch, or scrapping the batch.

After shaping, the final manufacturing process is curing. Like the other processes, curing has variables (such as heat and time) that can be monitored and controlled. A test sample can be tested in an RPA (not shown), to determine the quality of the curing operation. Data 60 from the curing process is sent to the central database 42 and stored for immediate and future use. Stored database values for cured dynamic properties of the product being processed are used to adjust and modify the cure process to anticipate the dynamic properties of the finished part. The ECLIPSE® software recommends actions to be taken such as adjusting the process parameters (i.e. process controls) through the machine control circuitry 46, reworking the batch, or scrapping the batch.

Therefore, at any process stage, all known information is being analyzed based on all available information accessible by the database (including information stored based on the prior process stages, known processability information, etc.), in order to determine the appropriate process parameters which will yield the desired result. The central database 42 also utilizes a “neural network” to gain access to information remote from the central database 42, including but not limited to supplier information, manufacturing information, production information, and production information.

In essence, because this invention utilizes known processability information and adds to that base of knowledge with subsequent processability information gathered during the production process, this invention gains an “artificial intelligence” with regard to the efficient and accurate production of a desired rubber product. Using the present invention, the entire rubber manufacturing process can be optimized by monitoring and quickly making adjustments to the manufacturing process based on this prior processability knowledge.

This invention utilizes RPA test instruments at the production line to test sample material directly off the line instead of sending the sample material to a lab in another area of the complex. Placing the test instrument on the production line is possible due to the development of a longer lasting seal die available from Alpha Technologies U.S., L.P. known as the “Permaseal Die”, shown in Brochure G and hereby incorporated by reference herein. The central database and software allow the manufacturing process to run without the need for a lab technician constantly monitoring each test and analyzing the results. By using the central database to store information and compare monitoring results with previously obtained and known results, the manufacturing process becomes quicker, more efficient, and obtains more reliable results.

It is obvious from this description that this invention could incorporate numerous types of testing equipment, tests, and evaluational and decisional software to evaluate and modify the manufacturing process. It is also obvious from this description that this invention could utilize many know or anticipated types of software and test instruments to monitor, evaluate, and modify the production process to achieve superior and more consistent results and still be within the scope of this invention. It is also obvious from this description that a number of tests, other than those specifically described in the examples above, could be programmed into the test instruments to perform any number of tests to evaluate the material and still be within the scope of this invention.

Having thus defined the invention, we claim:

1. A method for optimizing a rubber manufacturing process having multiple process steps, wherein said process steps can be adjusted during the manufacturing process to achieve a desired rubber product, said method comprising:
obtaining a rubber material sample during the manufacturing process;
analyzing said rubber material sample to generate processability data;
comparing said generated processability data with known processability data;
determining any process adjustments required to achieve optimal processability of said rubber material sample; and
means for implementing said process adjustments during the rubber manufacturing process to achieve a desired rubber product.

2. The method of claim 1 wherein said known processability data is stored in a central database.

3. The method of claim 2 wherein said analyzing step comprises measuring viscoelastic properties of said rubber material sample.

4. The method of claim 3 wherein said known processability data includes stored viscoelastic data from rubber material samples taken during various steps of the manufacturing process.

5. The method of claim 4 wherein said known processability data further includes suggested manufacturing process parameters necessary to obtain optimal processability characteristics of said rubber material sample based on said stored viscoelastic data.

6. The method of claim 5 wherein said comparing step is accomplished by a computer software program.

7. The method of claim 6 wherein said determining step is accomplished by a computer software program.

8. The method of claim 7 wherein said process adjustments are implemented in real-time during the manufacturing process.

9. The method of claim 8 wherein said process adjustments are utilized in a subsequent process step to optimize the manufacturing process.

10. The method of claim 9 wherein said process adjustments are utilized in a plurality of subsequent process steps to optimize the manufacturing process.

11. The method of claim 10 wherein said means for implementing said set of optimized process adjustments comprises a machine control circuit able to control and adjust a rubber processing machine.

12. The method of claim 11 wherein said measuring of said viscoelastic properties is accomplished by performing mechanical tests on said rubber material sample, said mechanical tests being performed by at least one instrument selected from the group consisting of rheometers, tensile testers, hardness testers, and viscometers.

13. A method for optimizing a rubber manufacturing process having multiple process steps, wherein said process steps can be adjusted during the manufacturing process to achieve a desired rubber product, said method comprising:
providing a central database having known processability data for a plurality of raw materials stored within;
obtaining at least one raw material sample;
analyzing said at least one raw material sample to determine processability data;
comparing said determined processability data of said raw material with said known processability data for a similar raw material;
determining optimal process parameters of said at least one raw material sample that includes a prescribed recipe for a rubber compound; and
preparing a rubber compound based on said prescribed recipe.

14. The method of claim 13 wherein said raw material includes at least one elastomeric polymer.

15. The method of claim 14 wherein said raw material further includes at least one filler material.

16. The method of claim 15 wherein said analyzing step comprises performing mechanical tests on said raw material sample, said mechanical tests being performed by at least one instrument selected from the group consisting of rheometers, tensile testers, hardness testers, and viscometers.

17. The method of claim 16 wherein said comparing step is accomplished by a computer software program.

18. The method of claim 17 wherein said determining step is accomplished by a computer software program.

19. A method for optimizing a rubber manufacturing process, said method comprising:
compounding at least one raw material to provide a rubber material;
means for analyzing said rubber material to generate processability data;
means for comparing said generated processability data with known processability data;
means for determining any process adjustments required to achieve optimal compounding of said rubber material; and
means for implementing said process adjustments during said compounding to achieve a desired rubber product.

20. The method of claim 19 wherein said known processability data is stored in a central database.

21. The method of claim 20 wherein means for analyzing comprises performing mechanical tests on said rubber material for measuring viscoelastic properties of said rubber material sample.

22. The method of claim 21 wherein said known processability data includes stored viscoelastic data from various rubber material samples taken during various compounding steps.

23. The method of claim 22 wherein said known processability data further includes suggested manufacturing process parameters necessary to obtain optimal compounding of said rubber material sample based on said stored viscoelastic data.

24. The method of claim 23 wherein said means for comparing is accomplished by a computer software program.

25. The method of claim 24 wherein said means for determining is accomplished by a computer software program.

26. The method of claim 25 wherein said means for implementing comprises means for controlling compounding time and speed parameters to obtain optimal compounding.

27. A method for optimizing a rubber manufacturing process, said method comprising:
shaping a rubber material;
means for analyzing said rubber material to generate processability data;
means for comparing said generated processability data with known processability data;
means for determining any process adjustments required to achieve optimal shaping of said rubber material; and
means for implementing said process adjustments during said shaping to achieve a desired rubber product.

28. The method of claim 27 wherein said known processability data is stored in a central database.

29. The method of claim 28 wherein means for analyzing comprises a rubber process analyzer for measuring viscoelastic properties of said rubber material sample.

30. The method of claim 29 wherein said known processability data includes stored viscoelastic data from various rubber material samples taken during various shaping steps.

31. The method of claim 30 wherein said known processability data further includes suggested manufacturing process parameters necessary to obtain optimal shaping of said rubber material sample based on said stored viscoelastic data.

32. The method of claim 31 wherein said means for comparing is accomplished by a computer software program.

33. The method of claim 32 wherein said means for determining is accomplished by a computer software program.

34. A method for optimizing a rubber manufacturing process, said method comprising:
curing a rubber material;
means for analyzing said rubber material to generate processability data;
means for comparing said generated processability data with known processability data;
means for determining any process adjustments required to achieve optimal curing of said rubber material; and
means for implementing said process adjustments during said curing to achieve a desired rubber product.

35. The method of claim 34 wherein said known processability data is stored in a central database.

36. The method of claim 35 wherein means for analyzing comprises a rubber process analyzer for measuring viscoelastic properties of said rubber material sample.

37. The method of claim 36 wherein said known processability data includes stored viscoelastic data from various rubber material samples taken during various curing steps.

38. The method of claim 37 wherein said known processability data further includes suggested manufacturing process parameters necessary to obtain optimal curing of said rubber material sample based on said stored viscoelastic data.

39. The method of claim 38 wherein said means for comparing is accomplished by a computer software program.

40. The method of claim 39 wherein said means for determining is accomplished by a computer software program.

41. The method of claim 40 wherein said means for implementing comprises means for controlling curing time and temperature parameters to obtain optimal cure.

42. A method for optimizing a rubber manufacturing process, said method comprising:
compounding at least one raw material to provide a rubber material;
means for analyzing said rubber material to generate processability data;
means for comparing said generated processability data with known processability data;
means for determining any process adjustments required to achieve optimal compounding of said rubber material;
means for implementing said process adjustments during said compounding to achieve a desired compounded rubber material;
shaping said rubber material;
means for analyzing said rubber material to generate processability data;
means for comparing said generated processability data with known processability data;
means for determining any process adjustments required to achieve optimal shaping of said rubber material; and
means for implementing said process adjustments during said shaping to achieve a desired rubber material;
curing said rubber material;
means for analyzing said rubber material to generate processability data;
means for comparing said generated processability data with known processability data;
means for determining any process adjustments required to achieve optimal curing of said rubber material; and
means for implementing said process adjustments during said curing to achieve a desired rubber product.

43. An apparatus for optimizing a rubber manufacturing process having multiple manufacturing steps, said apparatus comprising:
processing equipment for processing a material;
testing equipment for generating processability test data for a material sample;
a central database capable of receiving said processability test data, said central database having access to known processability data;
evaluation and decision-making software accessible by said central database for comparing said processability test data with said known processability data and determining any process adjustments required to achieve a desired processability; and
equipment control circuitry connecting the processing equipment and said central database to implement said process adjustments.

44. The apparatus of claim 43 wherein said processability data and known processability data comprises viscoelastic data and known viscoelastic data.

45. The apparatus of claim 44 wherein said known processability data includes stored viscoelastic data from material samples taken during various steps of the manufacturing process.

46. The apparatus of claim 45 wherein said known processability data further includes suggested manufacturing process parameters necessary to obtain optimal processability characteristics of said material sample based on said stored viscoelastic data.

47. The apparatus claim 46 wherein said process adjustments are implemented in real-time during the manufacturing process.

48. The apparatus of claim 47 wherein said process adjustments are utilized in a subsequent process step to optimize the manufacturing process.

49. The apparatus of claim 44 wherein the testing equipment for generating viscoelastic data is selected from the group consisting of rheometers, tensile testers, hardness testers, and viscometers.
